(19) United States
(12) Patent Application Publication
(10) Pub. No.: US 2025/0017300 A1
(43) Pub. Date: Jan. 16, 2025

(54) SUSTAINABLE SEQUINS AND PAILLETTES

(71) Applicants: Jessica CIARLA, Austin, TX (US); Nathaniel LYND, Austin, TX (US); Luisa FANDINO, Austin, TX (US); Jennifer IMBROGNO, Austin, TX (US)

(72) Inventors: Jessica CIARLA, Austin, TX (US); Nathaniel LYND, Austin, TX (US); Luisa FANDINO, Austin, TX (US); Jennifer IMBROGNO, Austin, TX (US)

(21) Appl. No.: 18/714,525

(22) PCT Filed: Dec. 2, 2022
(86) PCT No.: PCT/US2022/051703

§ 371 Date: May 29, 2024

Related U.S. Application Data
(60) Provisional application No. 63/285,430, filed on Dec. 2, 2021.

(51) Int. Cl. A41D 27/08; B44C 5/00

(52) U.S. Cl. CPC A41D 27/08; B44C 5/00

(57) ABSTRACT

Embodiments of the present disclosure pertain to biodegradable sequins that include: a polymeric component; and a decorative component combined with the polymeric component. In some embodiments, the biodegradable sequin has a dimmed appearance. Additional embodiments of the present disclosure pertain to methods of making the biodegradable sequins of the present disclosure by mixing a polymeric component with a decorative component to form a mixture; and applying the mixture onto a surface to form the biodegradable sequin. In some embodiments, the methods of the present disclosure also include a step of cutting the formed sequins into a desired shape.

### CROSS-REFERENCE TO RELATED APPLICATIONS

This application claims benefit of U.S. Provisional Application No. 63/285,430, filed Dec. 2, 2021, which is hereby incorporated herein by reference in its entirety.

### BACKGROUND

Sequins are frequently utilized in many textile applications to create decorative textures and designs. Conventional sequins typically utilize toxic dyes and pigments among other ecologically damaging plastics, causing a deleterious environmental effect from their widespread use. Once a sequin-containing piece is discarded, the metal or petroleum-based plastics are recalcitrant to degradation and can remain intact in a landfill for thousands of years. Moreover, current sequin products often contain harmful additives, which can leach microplastics and toxic chemicals into the water supply.

Beyond the substantial environmental impact, existing sequins have numerous quality-related limitations, such as flimsiness, making the sequin susceptible to breakage. Additionally, current methods of making sequins require expensive and complex equipment and further generate a large amount of wasted plastic material. Numerous embodiments of the present disclosure address these and other limitations.

### SUMMARY

In some embodiments, the present disclosure pertains to biodegradable sequins that include: a polymeric component; and a decorative component combined with the polymeric component. In some embodiments, the biodegradable sequin has a dimmed appearance. In some embodiments, the biodegradable sequin is in the form of a paillette, button, zipper, trimming, or combinations thereof. In some embodiments, the biodegradable sequin has a thickness of at least about 0.3 mm.

Additional embodiments of the present disclosure pertain to methods of making the biodegradable sequins of the present disclosure. In some embodiments, such methods include: mixing a polymeric component with a decorative component to form a mixture; and applying the mixture onto a surface to form the biodegradable sequin. In some embodiments, the methods of the present disclosure also include a step of cutting the formed sequins into a desired shape.

### DESCRIPTION OF THE FIGURES

FIG. 1 illustrates a method of making sequins.

FIG. 2 shows images of various sequins in the form of paillettes, including (from left to right) an oblong paillette, a large oval paillette, a small oblong paillette, a small oval paillette, a square paillette, a rectangular paillette, and a teardrop paillette. The dimensions are listed in Table 1.

FIG. 3 illustrates a specification sheet of a sample algae paillette.

FIGS. 4A and 4B show images of a sample algae paillette (FIG. 4A) and a standard paillette in the market (FIG. 4B).

FIGS. 5A and 5B show scanning electron microscopy (SEM) images of a sample algae paillette (FIG. 5A) and a standard paillette in the market (FIG. 5B).

FIGS. 6A and 6B show images of standard paillettes in the market (FIG. 6A) and sample algae paillettes (FIG. 6B).

FIG. 7 shows images of paillettes made from coffee polylactic acid (PLA) that were created from a spool that was cut, heat pressed and laser cut.

FIG. 8 shows images of paillettes made from hemp PLA that were created from a spool that was cut, heat pressed and laser cut.

FIG. 9 shows images of paillettes made from 6 g clear PLA and 0.5 g of biodegradable green glitter×2. The paillettes were created by mixing the components together in a beaker, pressing the material into sheets using a hot press and then laser cutting the shapes after the sheets had cooled.

FIG. 10 shows images of paillettes made from 6 g clear PLA and 0.5 g of biodegradable gold glitter×2. The paillettes were created by mixing the components together in a beaker, pressing the material into sheets using a hot press and then laser cutting the shapes after the sheets had cooled.

FIG. 11 shows images of paillettes made from 6 g clear PLA and 1 g of biodegradable chunky glitter×2. The paillettes were created by mixing the components together in a beaker, pressing the material into sheets using a hot press and then laser cutting the shapes after the sheets had cooled.

FIG. 12 shows an image of a sample button made according to one embodiment of the present disclosure.

FIG. 13 illustrates a specification sheet of a sample algae paillette.

FIG. 14 shows an image of sample paillettes in the shape of teardrops and ovals.

FIG. 15 shows an image depicting a collection of sample paillettes in various colors, textures and shapes.

FIG. 16 depicts a dispersion pattern of a pigment on a sample paillette.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Sequins find numerous applications in fabrics and garments. However, most sequins are non-biodegradable. Furthermore, many sequins have poor qualities, such as flimsiness. Additionally, current methods of making sequins require expensive and complex hole punching equipment that generate wasteful by-products. As such, a need exists for sequins that are biodegradable and rigid. A need also exists for more efficient and less wasteful methods of making sequins. Numerous embodiments of the present disclosure address the aforementioned needs.

In some embodiments, the present disclosure pertains to biodegradable sequins. As used herein, the term “biodegradable” refers to a material (e.g., a sequin) in which a significant portion of the components of the material (e.g., at least 25%, at least 30%, at least 40%, at least 50%, at least 60%, at least 70%, at least 75%, at least 80%, or at least 90% by mass) degrade to base molecules such as carbon dioxide, methane and/or water by reactions and the action of appropriate microorganisms within a reasonable limited time frame (e.g., 5 years, 3 years, 2, years, 1 year, etc.) under “ideal” biodegradation conditions (e.g., anaerobic digester, industrial compost, or the like), e.g., such as conditions under various ASTM biodegradability tests (e.g., ASTM D-5511-18, D-5526-18, D5338-15 (2021), or D-6691-17, each of which is hereby incorporated by reference in its entirety).

In some embodiments, the biodegradable sequins include a polymeric component and a decorative component. In some embodiments, the decorative component is combined with the polymeric component. In some embodiments, the biodegradable sequin has a dimmed appearance.

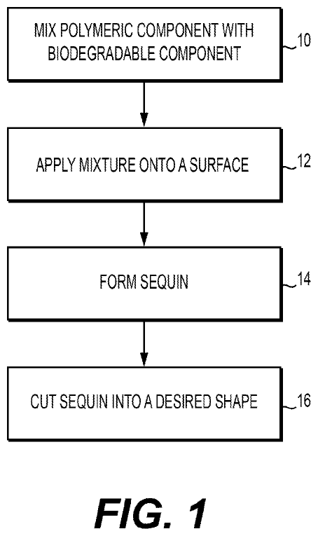

Additional embodiments of the present disclosure pertain to methods of making sequins. In some embodiments illustrated in FIG. 1, the methods of the present disclosure include: mixing a polymeric component with a biodegradable decorative component to form a mixture (step 10); and applying the mixture onto a surface (step 12) to form the sequin (step 14). In some embodiments, the methods of the present disclosure also include a step of cutting the sequin into a desired shape (step 16).

As set forth in more detail herein, the sequins of the present disclosure can include numerous polymeric components, decorative components, dimmed appearances, and forms. Additionally, various mixing, applying and cutting steps may be utilized to make the sequins of the present disclosure.

### Polymeric Components

Polymeric components generally refer to sequin materials that include one or more polymers. The sequins of the present disclosure can include numerous types of polymers. For instance, in some embodiments, the polymers include, without limitation, thermoplastic polymers, polyesters, polylactic acid (PLA), polybenzimidazole, polycarbonate, polyether sulfone, polyoxymethylene, polyether ether ketone, polyetherimide, polyethylene, polyphenylene oxide, polyphenylene sulfide, polypropylene, polystyrene, polyvinyl chloride, polyvinylidene fluoride, polytetrafluoroethylene (Teflon), and combinations thereof.

In various embodiments, the polymeric component includes a biodegradable polymer. In some embodiments, the biodegradable polymer can meet the pass levels for readily and ultimate biodegradability according to the OECD Guideline for Testing of Chemicals, Method 301 B: CO₂ Evolution (Modified Sturm Test). In some examples, the polymeric component is a biodegradable thermoplastic polymer, such as a biodegradable polyester. Example biodegradable thermoplastic polymers include, for example, polylactic acid (PLA); polycaprolactone (PCL); polybutylene succinate (PBS); polybutylene adipate terephthalate (PBAT); polyglycolic acid (PGA); polyhydroxyalkanoates such as poly-3-hydroxybutyrate (P3HB), poly-4-hydroxybutyrate (P4HB), poly-3-hydroxyvalerate (PHV), and copolymers thereof such as poly(3-hydroxybutyrate-co-3-hydroxyvalerate) (PHBV); copolymers thereof (e.g., poly(lactic-co-glycolic acid) (PLGA), and blends thereof. In some embodiments, the polymeric component can comprise a polyester, such as polylactic acid, polyglycolic acid, or a copolymer thereof. In some embodiments, the polymeric component can comprise polylactic acid (PLA).

### Decorative Components

The sequins of the present disclosure can include numerous types of decorative components. In some embodiments, the decorative component is an environmentally-friendly and/or biodegradable material. As used herein, reference to a “biodegradable decorative component” and the like refers to a non-toxic additive capable of degrading over time by water and/or enzymes found in nature, without harming the environment. For instance, in some embodiments, the decorative components include, without limitation, biodegradable glitter (e.g., mica glitter), biodegradable pigments, and combinations thereof.

In some embodiments, the decorative components include biodegradable pigments. As used herein, the term “biodegradable pigment” and the like refers to biodegradable or bio-derived materials added to provide a colorant effect. The biodegradable pigment can be a single colorant or a combination of different biodegradable colorants. In various examples, the decorative component can include a natural colorant, derivative thereof, or a combination thereof. A natural colorant is one that can be obtained or derived from plants (e.g., roots, berries, barks, leaves, woods, etc.), animals, insects, bacteria, protozoa, or fungus, or minerals. Non-limiting examples of such natural colorants include natural indigo blue, chlorophyll, and/or natural turmeric. For example, the biodegradable pigments can include, without limitation, pigments derived from agricultural waste, pigments derived from compostable materials, pigments derived from algae, pigments derived from hemp, pigments derived from coffee, pigments derived from spices, and combinations thereof.

### Biodegradable Sequins

The biodegradable sequins of the present disclosure can have various attributes. For instance, in some embodiments, the biodegradable sequins of the present disclosure are industrially compostable. As used herein, the term “compostable” refer to biodegradation into soil conditioning material (i.e., compost). In order for a plastic sequin to be labeled as commercially or industrially compostable it should be broken down by biological treatment at a commercial or industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the biodegradable sequin should occur at a rate similar to the other elements of the material being composted and leave no toxic residue that would adversely impact the ability of the finished compost to support plant growth. ASTM Standards D6400-21 and D6868-21 outline the specifications that must be met in order to label a plastic as industrially “compostable.” As an example, polylactic acid (PLA) is both biodegradable and industrially compostable. Furthermore, biodegradable polymers such as polylactic acid (PLA) do not harm the environment while they are degrading and after they have degraded completely.

The biodegradable materials of the present disclosure can be derived from various sources. For instance, in some embodiments, the biodegradable materials of the present disclosure are derived from agricultural waste. In some embodiments, the biodegradable component is Polylactic Acid (PLA) and is derived from agricultural waste. For example, polylactic acid (PLA) can be obtained from various natural renewable resource material including corn, plant starches (e.g., potatoes), and canes (e.g., sugar cane).

### Mixing of Polymeric and Decorative Components

Various methods may be utilized to mix polymeric and decorative components in order to form mixtures. For instance, in some embodiments, the mixing includes stirring. In some embodiments, the mixing includes the utilization of three-dimensional (3-D) printers.

The polymeric components of the present disclosure can be mixed with decorative components in various forms. For instance, in some embodiments, the polymeric component includes molten polymer. As such, in some embodiments, the methods of the present disclosure also include a step of melting the polymer.

In some embodiments, the polymeric component includes monomeric units of a polymer. As such, in some embodiments, the methods of the present disclosure also include a step of curing the monomeric units to form the polymer.

### Applying Mixtures to Surfaces

Various methods may also be utilized to apply mixtures of polymeric and biodegradable decorative onto surfaces. For instance, in some embodiments, the applying occurs by spraying the mixtures onto surfaces. In some embodiments, the applying occurs by pressing the mixtures onto surfaces. In some embodiments, the applying occurs by applying pressure onto surfaces.

In some embodiments, the applying occurs through the utilization of a 3-D printer. In some embodiments, the sequin formation methods of the present disclosure occur through the utilization of a 3-D printer. In some embodiments, the applying results in the formation of flat sheets of sequins on a surface.

The mixtures of the present disclosure may be applied to various surfaces. For instance, in some embodiments, the surface is a flat surface. In some embodiments, the surface is in the form of a mold. In some embodiments the paillettes are formed through 3D printing.

### Cutting of Sequins

In some embodiments, the methods of the present also include a step of cutting the flat sheet or formed sequins into a desired shape. In some embodiments, the cutting occurs by laser cutting. Exemplary laser cutting systems and methods can be found in U.S. Pat. No. 8,354,000, which is hereby incorporated by reference in its entirety. In some embodiments, the cutting results in the formation of a pattern.

In various embodiments, the method generates scrap material which can subsequently be reused or recycled. For example, the scrap material can be mechanically shredded and turned into plastic pellets. These plastic pellets can then be used as a raw material to make new sequins or other bioplastic materials. Recycling of unused scraps can increase the amount of raw material used and thereby lessen the environmental impact of the process.

### Sequin Structures

The sequins of the present disclosure can have various shapes. For instance, in some embodiments, the shapes include, without limitation, circular shapes, oval shapes, square-like shapes, rectangular shapes, oblong shapes, or combinations thereof. In some embodiments, the sequins have a circular shape.

The sequins of the present disclosure can also have various forms. For instance, in some embodiments, the sequins of the present disclosure are in the form of paillettes, buttons, zippers, trimmings, or combinations thereof. In some embodiments, the sequins of the present disclosure are in the form of paillettes. In some embodiments, the paillettes include, without limitation, oblong paillettes, large oval paillettes, small oblong paillettes, small oval paillettes, square paillettes, rectangular paillettes, teardrop paillettes, or combinations thereof.

The sequins of the present disclosure can have various colors. For instance, in some embodiments, the sequin colors include, without limitation, gold, green, black, grey, blue, brown, or combinations thereof.

The sequins of the present disclosure can have various thicknesses. For instance, in some embodiments, the sequins (e.g., in the form of paillettes) of the present disclosure, have thicknesses ranging from about 0.1 mm to about 10 mm. In some embodiments, the sequins of the present disclosure have thicknesses ranging from about 0.1 mm to about 5 mm. In some embodiments, the sequins of the present disclosure have thicknesses ranging from about 0.5 mm to about 1 mm. In some embodiments, the sequins of the present disclosure have thicknesses ranging from about 0.7 mm to about 0.8 mm.

In some embodiments, the sequins of the present disclosure have thicknesses of at least about 0.2 mm. In some embodiments, the sequins of the present disclosure have thicknesses of at least about 0.3 mm. In some embodiments, the sequins of the present disclosure have thicknesses of at least about 0.4 mm. In some embodiments, the sequins of the present disclosure have thicknesses of at least about 0.6 mm. In some embodiments, the sequins of the present disclosure have thicknesses of at least about 0.7 mm. In some embodiments, the sequins of the present disclosure have thicknesses of at least about 0.8 mm.

### Dimmed Appearance

The dimmed appearance of the sequins of the present disclosure may be characterized in various manners. For instance, in some embodiments, the dimmed appearance is characterized by a lustrous appearance. In some embodiments, the dimmed appearance is characterized by a matte appearance. In some embodiments used herein, the term “matte appearance” refers to surface of the sequin that has a gloss measurement of less than about 70 Gu (gloss units) as measured using ASTM D2457-08 Standard Test Method for Specular Gloss of Plastic Films and Solid Plastics at a 60 degree angle, with samples attached in a planar configuration to a flat optical black plate as a backing.

In some embodiments, the dimmed appearance is characterized by a brightness value of less than 80 CIE L. In some embodiments, the dimmed appearance is characterized by a brightness value of less than 70 CIE L. In some embodiments, the dimmed appearance is characterized by a brightness value of less than 60 CIE L. In some embodiments, the dimmed appearance is characterized by a brightness value of less than 50 CIE L. In some embodiments, the dimmed appearance is characterized by a brightness value of less than 40 CIE L.

In some embodiments, the dimmed appearance is characterized by a glossiness level of less than 250 Gu (gloss units). In some embodiments, the dimmed appearance is characterized by a glossiness level of less than 100 Gu (gloss units). In some embodiments, the dimmed appearance is characterized by a glossiness level of less than 75 Gu (gloss units). In some embodiments, the dimmed appearance is characterized by a glossiness level of less than 50 Gu (gloss units). In some embodiments, the dimmed appearance is characterized by a glossiness level of less than 40 Gu (gloss units). In some embodiments, the dimmed appearance is characterized by a glossiness level of less than 35 Gu (gloss units). In some embodiments, the dimmed appearance is characterized by a glossiness level of less than 30 Gu (gloss units).

### Uneven Surfaces

In some embodiments, the sequins of the present disclosure may have an uneven surface. In some embodiments, the uneven surfaces are defined by peaks, basins, and combinations thereof.

In some examples, the biodegradable sequins include a textured surface characterized by an average surface roughness (Ra). The “average surface roughness” refers to an arithmetic average of absolute values of differences between the average surface height and each surface height over a representative planar section of the sequin. In some embodiments, the average surface roughness of the sequin of 1 μm or more, such as 2 μm or more, 3 μm or more, 4 μm or more, 5 μm or more, 6 μm or more, 7 μm or more, 8 μm or more, 9 μm or more, or 10 μm or more.

In some embodiments, the biodegradable sequins of the present disclosure have a matte finish. In some embodiments, the biodegradable sequins of the present disclosure have a texture and an uneven color that conveys the natural aesthetic look.

### Advantages and Applications

The sequins and methods of the present disclosure provide numerous advantages and applications. For instance, unlike pre-existing sequins, which are typically made out of non-biodegradable plastics, the sequins of the present disclosure can be composted, thereby providing a sustainable and biodegradable option. Moreover, unlike pre-existing sequins, which have thin and have flimsy qualities, the sequins of the present disclosure provide more stable structures along with novel looks, feels, and textures.

The methods of the present disclosure also provide various advantages. For instance, in some embodiments, the methods of the present disclosure provide efficient methods of making sequins without generating substantial waste. For instance, scraps created from laser cutouts can be heated, pressed down and reused to create a zero waste product.

In a specific embodiment, biodegradable sequins can be made by mixing together polylactic acid (PLA) and natural non-toxic pigments. Like the core materials, these pigments do not cause harm to the environment during the process of or after degradation, and remain inert once the degradation has been completed. This pigmented polylactic acid (PLA) can then be used in 3D printing sequins by way of extrusion while at the same time minimizing wasted product.

As such, the methods and sequins of the present disclosure can find numerous applications. For instance, in some embodiments, the methods of the present disclosure can be utilized to make sequins for numerous applications, such as use as buttons, zipper pulls and other trimmings.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Sustainable Sequins and Paillettes

This Example illustrates the facile fabrication of sustainable sequins and paillettes. Applicant purchased polylactic acid (PLA) clear pellets, melted them down, and mixed them with biodegradable glitters and pigments derived from algae, hemp, and coffee to create a non-toxic color. In the case of the pigmented polylactic acid (PLA), the pigment degrades simultaneously with the actual product. During the process of degradation and once degraded, it does not have any negative environmental impact. Thereafter, Applicant poured the mixture onto a Teflon sheet and then pressed the material using a heat setting and 6000 pounds of pressure. Next, Applicant laser cut the sheets onto custom designed shapes.

Applicant purchased biodegradable PLA infused with color from manufactures in the form of spools. Applicant cut the spools up into pellets, pressed them into a sheet and laser cut custom designed shapes. Applicant used a 3D printer to print out the paillettes and sequins directly onto the bed using sustainable PLA options.

Applicant created a novel design for the product using a 3D Fusion 360 CAD software, then converted the file into gcode. From there, the file was uploaded to a 3D printer that was set up with a spool of one of the coffee or hemp pigmented polylactic acid (PLA). The printer then printed only the desired product, leaving no waste behind. These products have a rougher texture on the surface than the ones that had been laser cut due to the printing process. As opposed to a uniform surface, the 3D printer forms products by extruding the aforementioned polylactic acid (PLA) into concentric circles.

### Example 1.1. Thickness Measurements

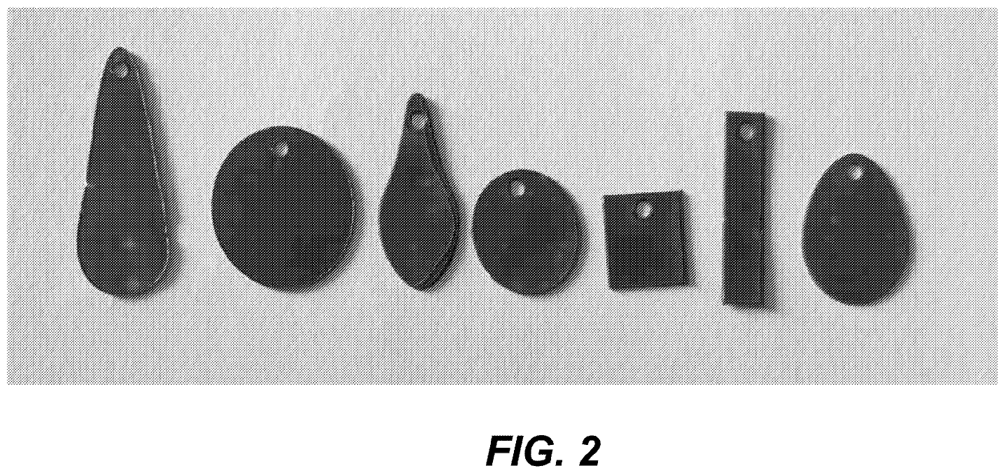

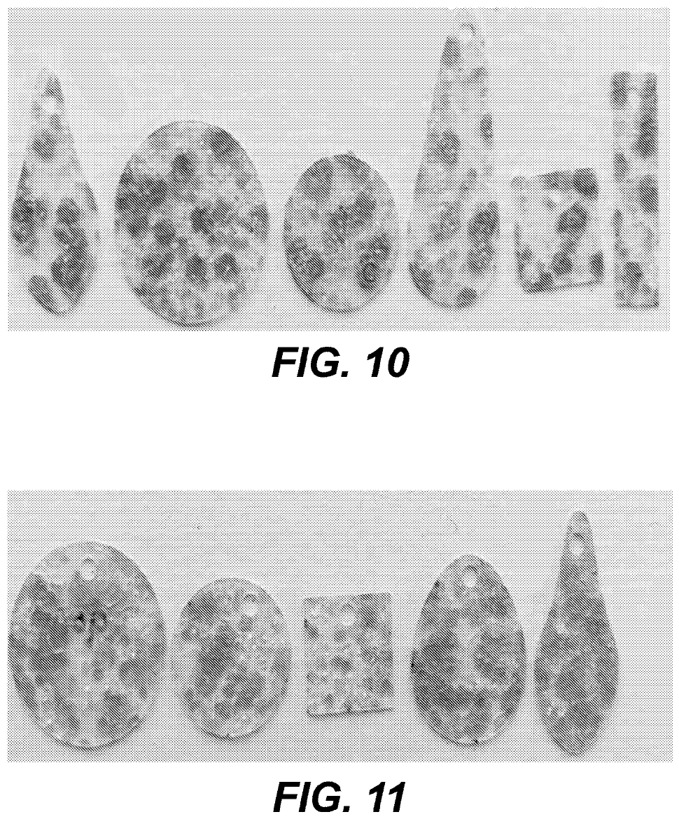

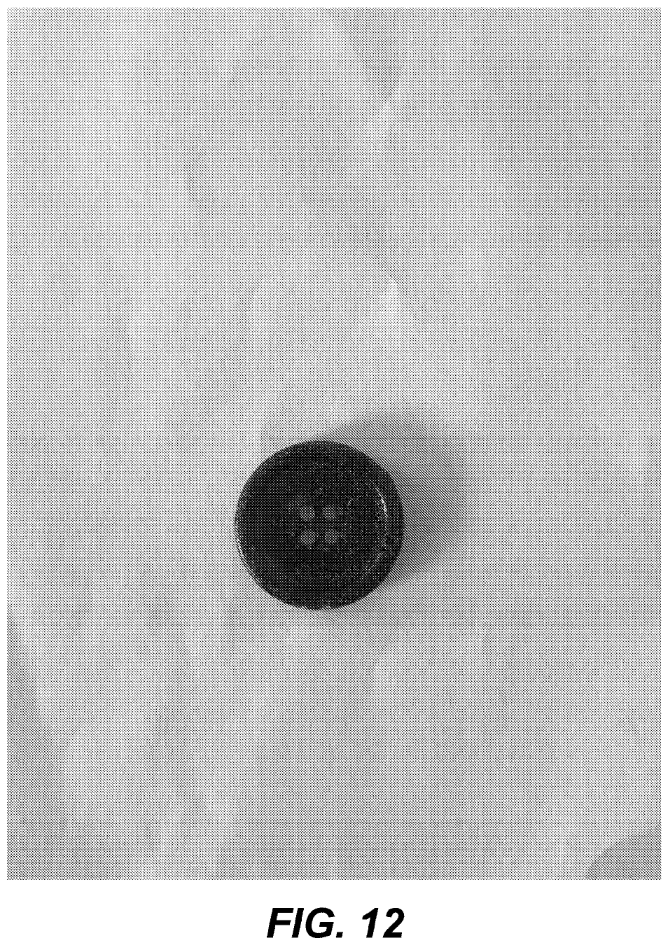

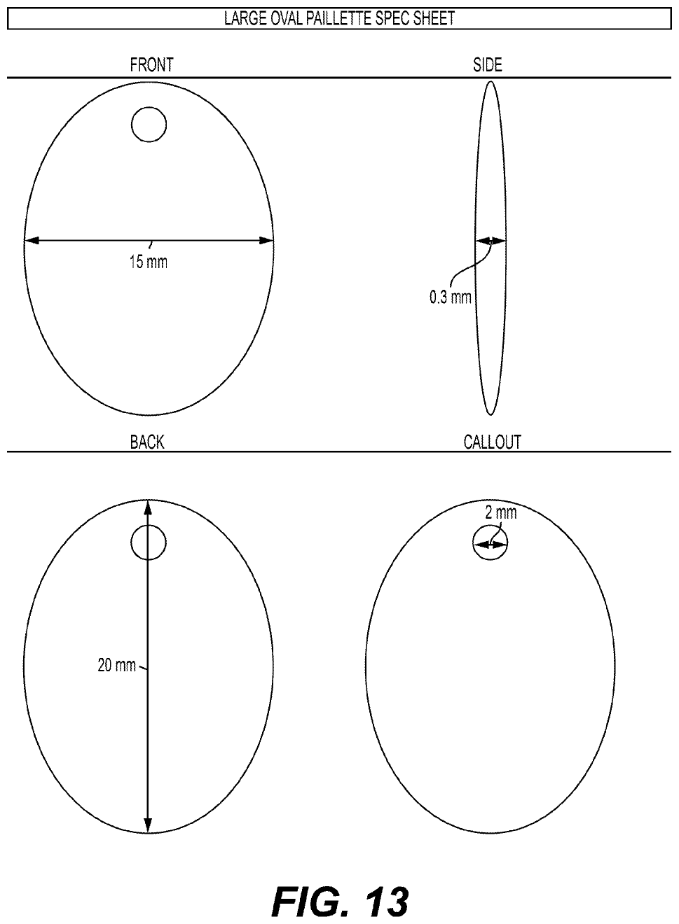

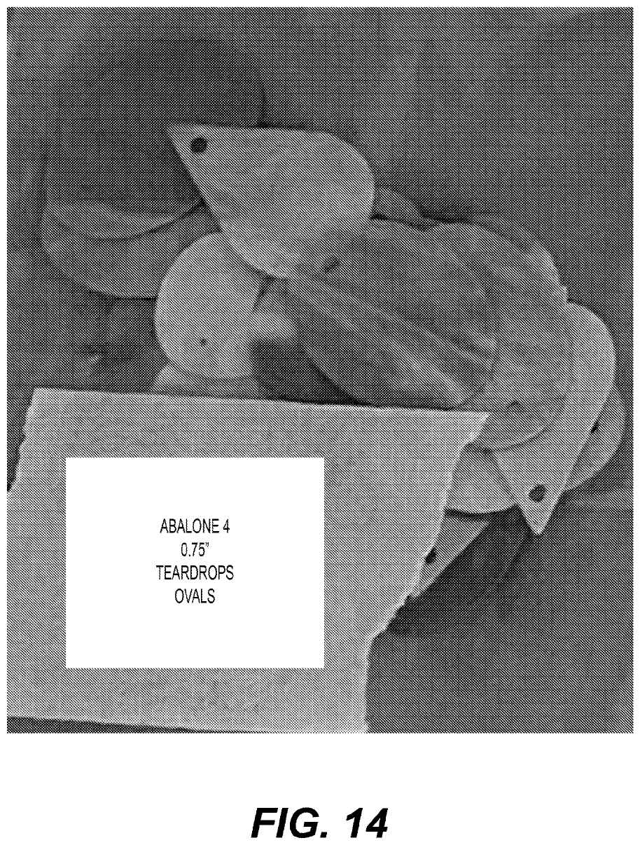

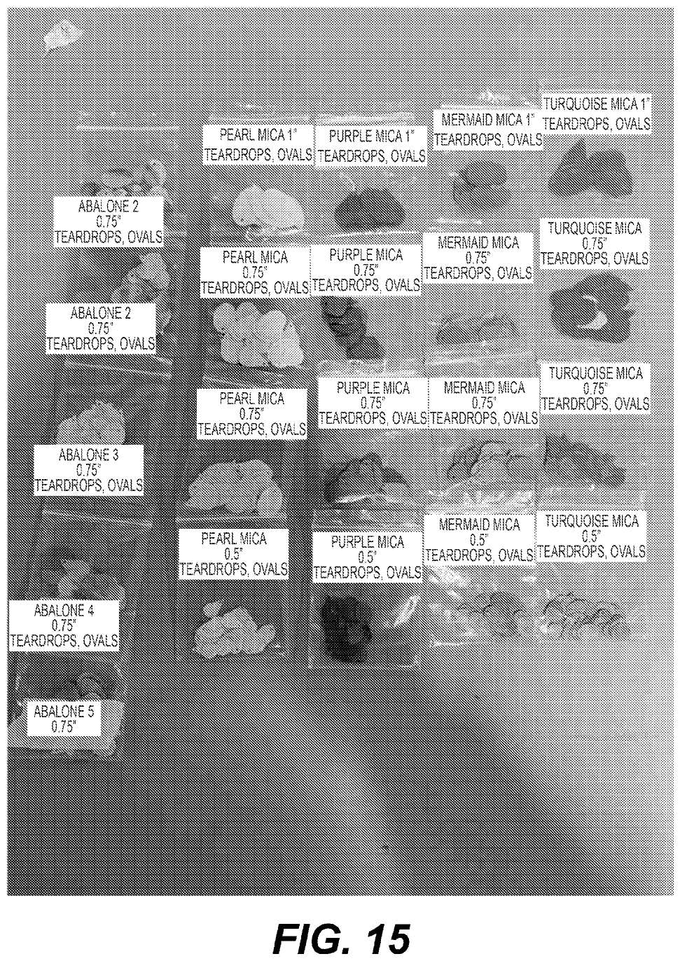

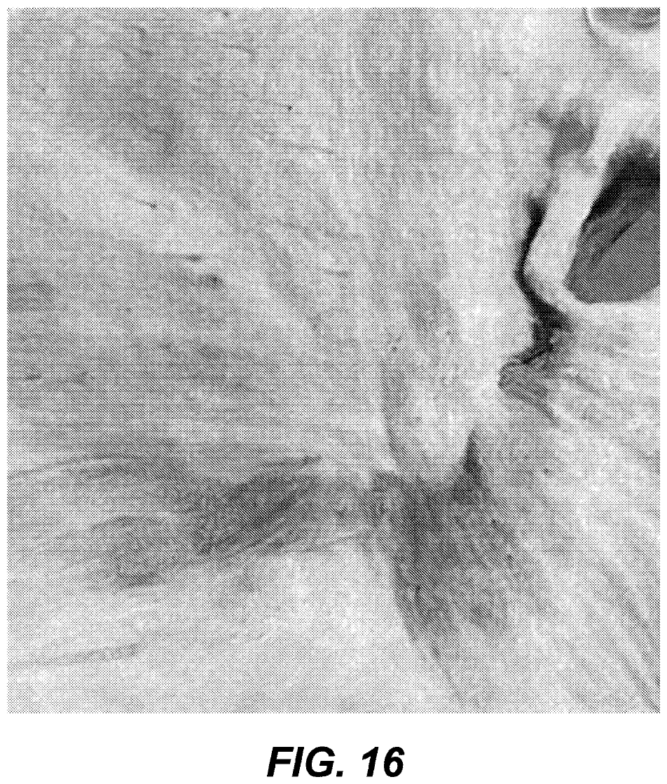

As summarized in Table 1 and illustrated in FIGS. 2-11, Applicant fabricated various types of sequins and paillettes through the aforementioned processes. Average sequin and paillette thicknesses are about 0.1 millimeters. However, Applicant's sequins and paillettes had thicknesses ranging from 0.3-0.8 millimeters.

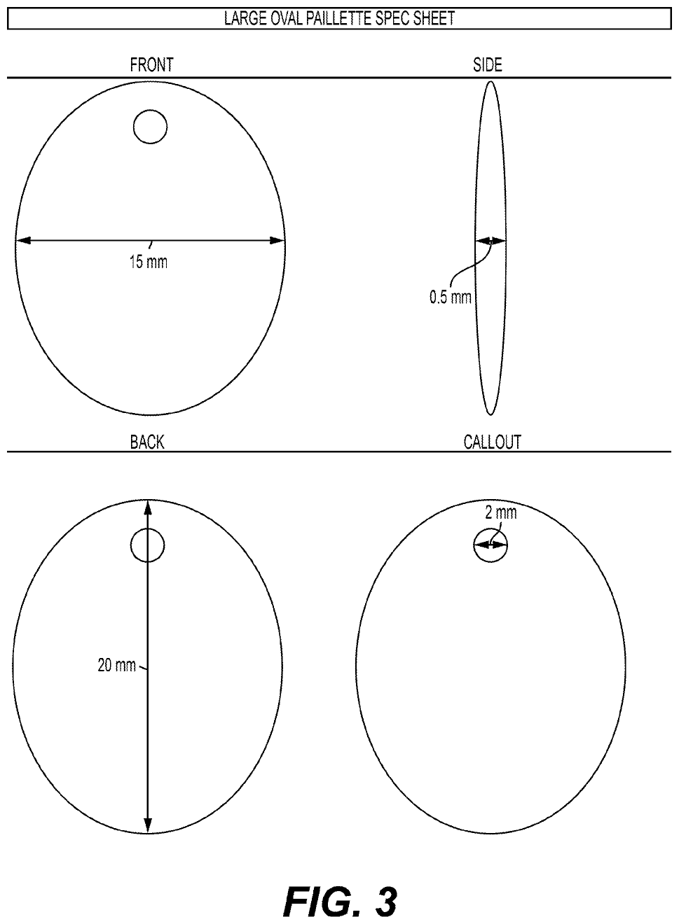

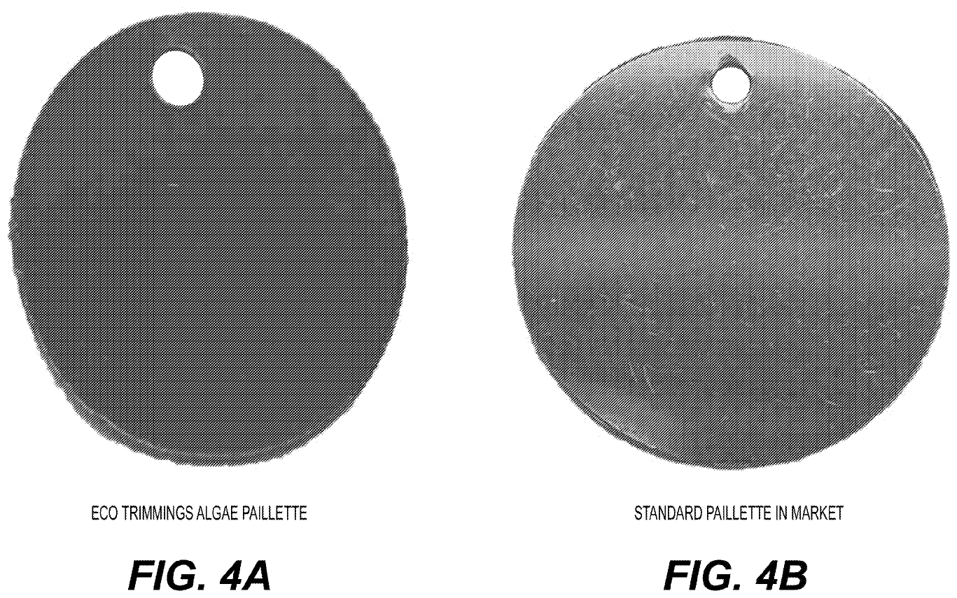

For instance, as depicted in FIG. 3, one of Applicant's sequins and paillettes showed a thickness of 0.5 mm. Similarly, the images in FIGS. 4A-B show an example of an algae paillette (FIG. 4A) made from biomaterials and a standard sequin (FIG. 4B) made with plastic material. The thickness in the paillette in FIG. 4A measures 0.5 mm and the thickness of the paillette in FIG. 4B measures 0.1 mm in thickness.

TABLE 1
Types of fabricated sequins and paillettes.

| | | | | Average |
|---|---|---|---|---|
| Name | Width | Height | Bevel | Thickness |
| Algae Oblong | 1 cm | 3 cm | N/A | 0.5 mm |
| paillette | | | | |
| Algae Large | 1.5 cm | 2 cm | N/A | 0.5 mm |
| oval paillette | | | | |
| Algae Small | 0.9 cm | 2.3 cm | N/A | 0.5 mm |
| oblong paillette | | | | |
| Algae Small | 1.1 cm | 1.39 cm | N/A | 0.5 mm |
| oval paillette | | | | |
| Algae Square | 0.79 cm | 0.9 cm | N/A | 0.5 mm |
| paillette | | | | |
| Algae Rectangle | 3 mm | 2.3 cm | N/A | 0.5 mm |
| paillette | | | | |
| Algae Teardrop | 1.1 cm | 1.7 cm | N/A | 0.5 mm |

### Example 1.2. Texture Measurements

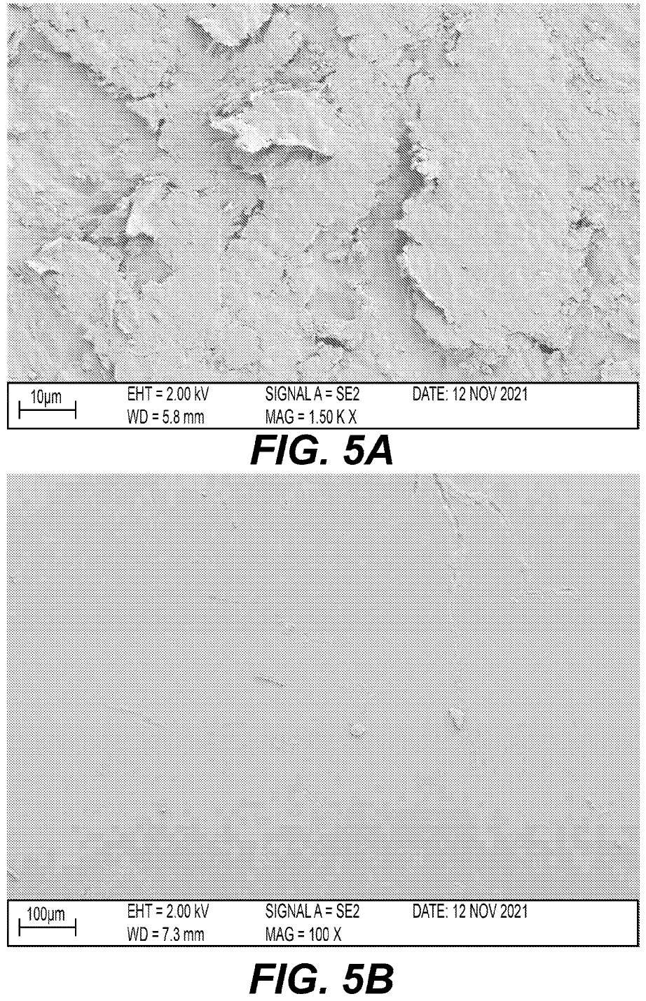

The textures of the surfaces of Applicant's sequins and paillettes are significantly less smooth than the textures of the surfaces of commercial sequins. For instance, scanning electron microscope (SEM) images of Applicant's green algae paillette (FIG. 5A) and a commercial green paillette (FIG. 5B) illustrate that Applicant's sequins and paillettes have rougher surfaces.

### Example 1.3. Brightness Measurements

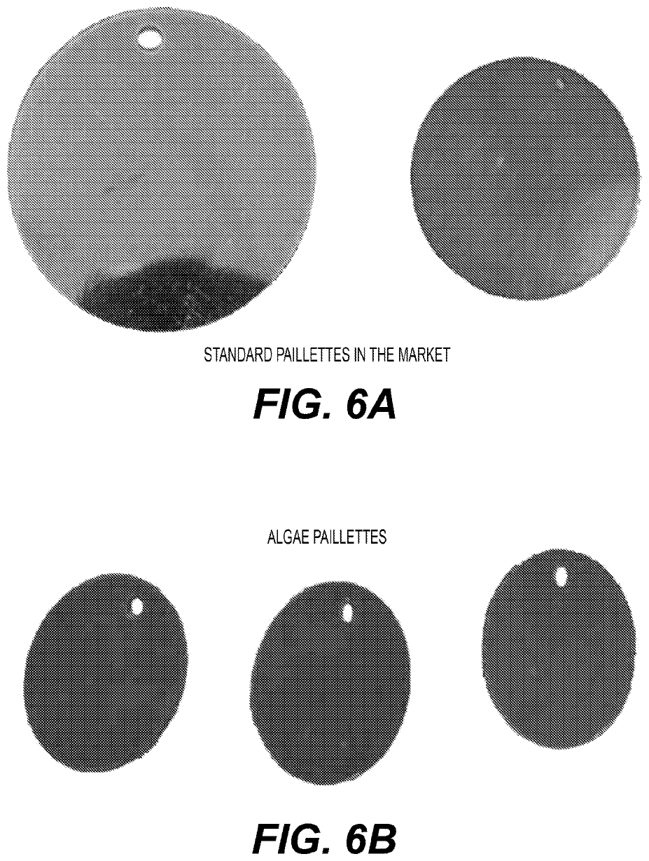

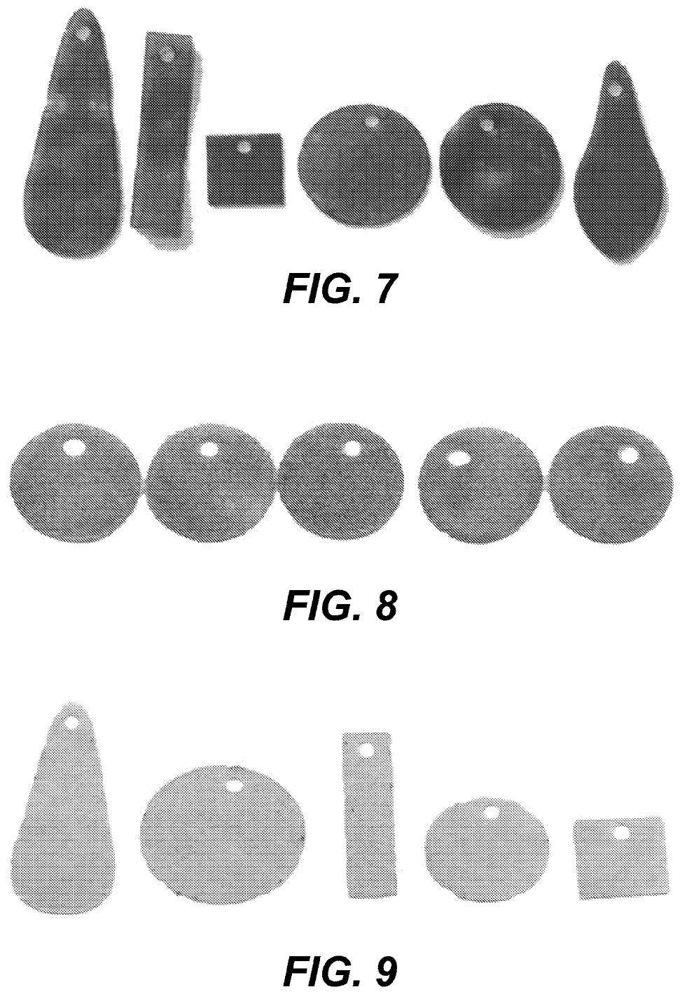

Applicant's sequins and paillettes are less bright than standard paillettes and sequins in the market. For instance, as illustrated in FIGS. 6A-6B, the standard green and blue paillettes (FIG. 6A) show a significant difference in measurement of brightness compared to Applicant's green algae PLA paillettes (FIG. 6B). Similarly, Applicant's paillettes made from coffee PLA (FIG. 7), hemp PLA (FIG. 8), and biodegradable green glitter (FIGS. 9-11).

Table 2 shows the results from a brightness test of Applicant's algae green paillettes against a commercial standard paillette. Spectrophotometers, which measure the amount of light reflecting from a surface, were utilized in the brightness tests.

TABLE 2
Datacolor 200: Brightness test table.

| BATCH | | | | | | | CIE Lab P/F |
|---|---|---|---|---|---|---|---|
| NAME | CIE DL | CIE Da | CIE Db | CIE DC | CIE DH | CIE DE | Determination |
| Algae | −52.44 | 17.33 | −67.35 | −68.02 | 14.48 | 87.10 | FAIL |
| Green1 | | | | | | | |
| Algae | −52.09 | 17.22 | −67.24 | −67.87 | 14.54 | 86.78 | FAIL |
| Green 2 | | | | | | | |
| Algae | −52.86 | 18.44 | −68.09 | −69.33 | 13.02 | 88.15 | FAIL |
| Green 3 | | | | | | | |

The lightness (reflectance) of Applicant's algae green paillettes is less than that of the commercial paillette (CIE L=89.21). Applicant's algae green paillette lightness CIE L is 36.75 (calculated as 89.21−(52.44+52.09+52.86)/3=36.75). The algae sample color is significantly different from that of the commercial paillette, which is 87.34 (CIE DE is (87.10+86.78+88.75)/3=87.34).

Based on the brightness test results, the commercial paillette brightness level was 89.21 CIE L while Applicant's algae paillette brightness level was 36.75 CIE L. Based on the L value representing lightness, the DE shows that the algae prototypes are significantly darker and have less shine than the commercial paillette sample. The deviation is extremely out of tolerance, concluding that the Applicant's paillettes and sequins are quantifiably darker with less brightness than the commercial paillettes.

As measured in the Datacolor 200 Spectrophotometer (Table 2), the brightness of the algae paillettes was tested against the standard commercial paillette and repeated with three samples. The results concluded that the algae samples failed in comparison to the commercial paillettes with a significant difference in brightness measurement. This quantifiable result concludes that the algae finish does not have the same level of color brightness as a commercial paillette. The matte appearance offers a new aesthetic selection to the current options in the market.

Additionally, Applicant performed a comparative gloss test by utilizing an AMSTAT Digital LCD Gloss Meter Tester. Applicant observed that the glossiness level of a commercial paillette was 368 Gu (gloss units) while the glossiness level of Applicant's algae paillette was 29.2 Gu (gloss units).

### Example 1.4. Biodegradability Measurements

In order to evaluate the biodegradability of Applicant's paillettes under composting conditions, a boiling test was performed on three commercial sequin paillettes and three of Applicant's algae sequin paillettes. The weight of each paillette was taken of each sample in both dry and wet conditions prior to the study and then again at 10-minute, 20-minute, 30-minute and 60-minute marks after leaving the samples in a boiling pot full of water. The final weight at the 60-minute mark concluded that the algae paillettes biodegraded 0.01 gn more than the commercial paillettes. The results are summarized in Table 3.

TABLE 3
Biodegradability measurements of paillettes.
Algae Paillettes (Wet Samples @ 0 min) 2.82 gn + 1.60 gn + 1.10 gn = 5.52/3 = 1.84 gn
Algae Paillettes (Wet Samples @ 60 min) 2.72 gn + 11.54 gn + .96 gn = 5.24/3 = 1.74 gn
Algae paillette change in weight = .10 gn
Commercial Paillettes (Wet Samples @ 0 min) 1.38 gn + 1.40 gn + 1.36 gn = 4.14/3 = 1.38 gn
Commercial Paillettes (Wet Samples @60 min) 1.29 gn + 1.29 gn + 1.29 gn = 3.87/3 = 1.29 gn
Commercial paillette change in weight = .9 gn

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A biodegradable sequin comprising:
a polymeric component; and
a decorative component combined with the polymeric component,
wherein the biodegradable sequin has a dimmed appearance.

2. The biodegradable sequin of claim 1, wherein the polymeric component comprises a polymer selected from the group consisting of thermoplastic polymers, polyesters, polylactic acid (PLA), polybenzimidazole, polycarbonate, polyether sulfone, polyoxymethylene, polyether ether ketone, polyetherimide, polyethylene, polyphenylene oxide, polyphenylene sulfide, polypropylene, polystyrene, polyvinyl chloride, polyvinylidene fluoride, polytetrafluoroethylene (Teflon), and combinations thereof.

3. The biodegradable sequin of any of claims 1-2, wherein the polymeric component comprises a biodegradable polymer.

4. The biodegradable sequin of any of claims 1-3, wherein the polymeric component comprises a thermoplastic.

5. The biodegradable sequin of any of claims 1-4, wherein the polymeric component comprises a polyester.

6. The biodegradable sequin of any of claims 1-5, wherein the polymeric component comprises polylactic acid (PLA); polycaprolactone (PCL); polybutylene succinate (PBS); polybutylene adipate terephthalate (PBAT); polyglycolic acid (PGA); polyhydroxyalkanoates such as poly-3-hydroxybutyrate (P3HB), poly-4-hydroxybutyrate (P4HB), poly-3-hydroxyvalerate (PHV), and copolymers thereof such as poly(3-hydroxybutyrate-co-3-hydroxyvalerate) (PHBV); copolymers thereof (e.g., poly(lactic-co-glycolic acid) (PLGA), and blends thereof.

7. The biodegradable sequin of any of claims 1-6, wherein the polymeric component comprises polylactic acid (PLA).

8. The biodegradable sequin of any of claims 1-7, wherein the decorative component is selected from the group consisting of biodegradable glitter, biodegradable pigments, and combinations thereof.

9. The biodegradable sequin of any of claims 1-8, wherein the decorative component comprises a biodegradable pigment, wherein the biodegradable pigment is selected from the group consisting of pigments derived from agricultural waste, pigments derived from compostable materials, pigments derived from algae, pigments derived from hemp, pigments derived from coffee, and combinations thereof.

10. The biodegradable sequin of any of claims 1-9, wherein the decorative component is compostable.

11. The biodegradable sequin of any of claims 1-10, wherein the decorative component is derived from agricultural waste.

12. The biodegradable sequin of any of claims 1-11, wherein the dimmed appearance is characterized by a lustrous appearance.

13. The biodegradable sequin of any of claims 1-12, wherein the dimmed appearance is characterized by a brightness value of less than 80 CIE L.

14. The biodegradable sequin of any of claims 1-13, wherein the dimmed appearance is characterized by a brightness value of less than 50 CIE L.

15. The biodegradable sequin of any of claims 1-14, wherein the dimmed appearance is characterized by a brightness value of less than 40 CIE L.

16. The biodegradable sequin of any of claims 1-15, wherein the dimmed appearance is characterized by a glossiness level of less than 250 Gu (gloss units).

17. The biodegradable sequin of any of claims 1-16, wherein the dimmed appearance is characterized by a glossiness level of less than 50 Gu (gloss units).

18. The biodegradable sequin of any of claims 1-17, wherein the dimmed appearance is characterized by a glossiness level of less than 30 Gu (gloss units).

19. The biodegradable sequin of any of claims 1-18, wherein the dimmed appearance is characterized by a matte appearance.

20. The biodegradable sequin of any of claims 1-19, wherein the biodegradable sequin comprises a shape selected from the group consisting of a circular shape, an oval shape, a square-like shape, a rectangular shape, an oblong shape, or combinations thereof.

21. The biodegradable sequin of any of claims 1-20, wherein the biodegradable sequin is in the form of a paillette, button, zipper, trimming, or combinations thereof.

22. The biodegradable sequin of any of claims 1-21, wherein the biodegradable sequin is in the form of a paillette.

23. The biodegradable sequin of any of claims 1-22, wherein the biodegradable sequin has a color selected from the group consisting of gold, green, black, grey, blue and brown.

24. The biodegradable sequin of any of claims 1-23, wherein the sequin comprises a paillette having a thickness of at least about 0.2 mm.

25. The biodegradable sequin of any of claims 1-24, wherein the sequin comprises a paillette having a thickness of at least about 0.4 mm.

26. The biodegradable sequin of any of claims 1-25, wherein the sequin comprises a paillette having a thickness of at least about 0.6 mm.

27. The biodegradable sequin of any of claims 1-26, wherein the sequin comprises a paillette having a thickness of at least about 0.8 mm.

28. The biodegradable sequin of any of claims 1-27, wherein the biodegradable sequin has an uneven surface.

29. The biodegradable sequin of claim 28, wherein the uneven surface is defined by peaks, basins, and combinations thereof.

30. A method of making a biodegradable sequin, said method comprising:
mixing a polymeric component with a decorative component to form a mixture; and
applying the mixture onto a surface to form the biodegradable sequin,
wherein the formed biodegradable sequin has a dimmed appearance.

31. The method of claim 30, wherein the mixing comprises stirring.

32. The method of any of claim 26, wherein the polymeric component comprises a polymer selected from the group consisting of thermoplastic polymers, polyesters, polylactic acid (PLA), polybenzimidazole, polycarbonate, polyether sulfone, polyoxymethylene, polyether ether ketone, polyetherimide, polyethylene, polyphenylene oxide, polyphenylene sulfide, polypropylene, polystyrene, polyvinyl chloride, polyvinylidene fluoride, polytetrafluoroethylene (Teflon), and combinations thereof.

33. The method of any of claims 30-32, wherein the polymeric component comprises a biodegradable polymer.

34. The method of any of claims 30-33, wherein the polymeric component comprises a thermoplastic.

35. The method of any of claims 30-34, wherein the polymeric component comprises a polyester.

36. The method of any of claims 30-35, wherein the polymeric component comprises polylactic acid (PLA); polycaprolactone (PCL); polybutylene succinate (PBS); polybutylene adipate terephthalate (PBAT); polyglycolic acid (PGA); polyhydroxyalkanoates such as poly-3-hydroxybutyrate (P3HB), poly-4-hydroxybutyrate (P4HB), poly-3-hydroxyvalerate (PHV), and copolymers thereof such as poly(3-hydroxybutyrate-co-3-hydroxyvalerate) (PHBV); copolymers thereof (e.g., poly(lactic-co-glycolic acid) (PLGA), and blends thereof.

37. The method of any of claims 30-36, wherein the polymeric component comprises polylactic acid (PLA).

38. The method of any of claims 30-37, wherein the polymeric component comprises molten polymer.

39. The method of any of claims 30-38, further comprising a step of melting the polymer.

40. The method of any of claims 30-39, wherein the polymeric component comprises monomeric units of a polymer.

41. The method of any of claims 30-40, further comprising a step of curing the monomeric units to form the polymer.

42. The method of any of claims 30-41, wherein the applying occurs by spraying the mixture onto the surface.

43. The method of any of claims 30-42, wherein the applying occurs by pressing the mixture onto the surface.

44. The method of any of claims 30-43, wherein the surface is a flat surface.

45. The method of any of claims 30-44, wherein the surface is in the form of a mold.

46. The method of any of claims 30-45, further comprising a step of cutting the formed biodegradable sequins into a desired shape.

47. The method of any of claims 30-46, wherein the method occurs through the utilization of a three-dimensional (3-D) printer.

48. The method of any of claims 30-47, wherein the decorative component is selected from the group consisting of biodegradable glitter, biodegradable pigments, and combinations thereof.

49. The method of any of claims 30-48, wherein the decorative component comprises biodegradable pigments, wherein the biodegradable pigments are selected from the group consisting of pigments derived from agricultural waste, pigments derived from compostable materials, pigments derived from algae, pigments derived from hemp, pigments derived from coffee, and combinations thereof.

50. The method of any of claims 30-49, wherein the decorative component is compostable.

51. The method of any of claims 30-50, wherein the decorative component is derived from agricultural waste.

52. The method of any of claims 30-51, wherein the dimmed appearance is characterized by a lustrous appearance.

53. The method of any of claims 30-52, wherein the dimmed appearance is characterized by a brightness value of less than 80 CIE L.

54. The method of any of claims 30-53, wherein the dimmed appearance is characterized by a brightness value of less than 50 CIE L.

55. The method of any of claims 30-54, wherein the dimmed appearance is characterized by a brightness value of less than 40 CIE L.

56. The method of any of claims 30-55, wherein the dimmed appearance is characterized by a glossiness level of less than 250 Gu (gloss units).

57. The method of any of claims 30-56, wherein the dimmed appearance is characterized by a glossiness level of less than 50 Gu (gloss units).

58. The method of any of claims 30-57, wherein the dimmed appearance is characterized by a glossiness level of less than 30 Gu (gloss units).

59. The method of any of claims 30-58, wherein the dimmed appearance is characterized by a matte appearance.

60. The method of any of claims 30-59, wherein the biodegradable sequin comprises a shape selected from the group consisting of a circular shape, an oval shape, a square-like shape, a rectangular shape, an oblong shape, or combinations thereof.

61. The method of any of claims 30-60, wherein the biodegradable sequin is in the form of a paillette, button, zipper, trimming, or combinations thereof.

62. The method of any of claims 30-61, wherein the biodegradable sequin is in the form of a paillette.

63. The method of any of claims 30-62, wherein the biodegradable sequin has a color selected from the group consisting of gold, green, black, grey, blue and brown.

64. The method of any of claims 30-63, wherein the biodegradable sequin comprises a paillette having a thickness of at least about 0.2 mm.

65. The method of any of claims 30-64, wherein the biodegradable sequin comprises a paillette having a thickness of at least about 0.4 mm.

66. The method of any of claims 30-65, wherein the biodegradable sequin comprises a paillette having a thickness of at least about 0.6 mm.

67. The method of any of claims 30-66, wherein the biodegradable sequin comprises a paillette having a thickness of at least about 0.8 mm.

68. The method of any of claims 30-67, wherein the biodegradable sequin has an uneven surface.

69. The method of claim 68, wherein the uneven surface is defined by peaks, basins, and combinations thereof.
